(19) United States
(12) Patent Application Publication
(10) Pub. No.: US 2015/0053436 A1
(43) Pub. Date: Feb. 26, 2015

(54) Traction Tillage System

(71) Applicant: Thomas Manning Thompson, Florence, AL (US)

(72) Inventor: Thomas Manning Thompson, Florence, AL (US)

(21) Appl. No.: 13/972,907

(22) Filed: Aug. 22, 2013

(51) Int. Cl. A01B 35/32

(52) U.S. Cl. CPC A01B 35/32
USPC 172/23

(57) ABSTRACT

A field tillage system that reduces soil compaction, fuel consumption, and dust pollution includes a pair of wheeled support assemblies, a pair of booms connected to the wheeled support assemblies so that the booms can be moved up and down with respect to the wheeled support assemblies and in and out with respect to one another, a pair of carriages connected to the booms so that the carriages can be moved hack and forth along the booms, a set of implements connected to the carriages for tilling a field as the carriages move back and forth along the booms, and a drive system connected to the carriages for simultaneously moving the carriages and implements in opposite directions creating opposing forces thereby producing their own traction as they move along the booms.

### CROSS REFERENCE TO RELATED APPLICATIONS

The present application claims priority on U.S. provisional patent application Ser. No. 61/684,102, filed on Aug. 31, 2012 and entitled “Traction Plowing System.” The '102 application is hereby incorporated by reference.

### BACKGROUND OF THE INVENTION

The present invention relates generally to tillage systems for farming. More specifically, the present invention pertains to a traction tillage system for farming.

Tillage systems for farming are known in the art. These systems typically include a tractor pulling implements, such as plows, planters, disks, harrows, cultivators, and irrigation spray heads, hack and forth across a field. Conventional tillage systems, however, have several disadvantages. Tractors are heavy and compact soil as they move back and forth across a field. Compacted soil can reduce crop yield by 10-20 percent depending on the extent of the compaction. Conventional tillage systems also use large amounts of fuel because the tractor has to go back and forth across the field repeatedly in order to till the entire field. Finally, conventional tillage systems can create large amounts of dust as the tractor moves back and forth across the field. Accordingly, there is a need for a tillage system that does not suffer from these disadvantages.

### SUMMARY OF THE INVENTION

The present invention addresses this need by providing a traction tillage system that reduces soil compaction, fuel consumption, and dust pollution. In one embodiment, the traction tillage system includes a pair of booms, a pair of wheeled support assemblies connected to, and providing support for, the booms, a pair of carriages connected to the booms so the carriages can move back and forth along the booms, a set of implements connected to the carriages for tilling a field as the carriages move back and forth along the booms, and a carriage drive system connected to the carriages and booms for simultaneously moving the carriages in opposite directions along the booms.

### BRIEF DESCRIPTION OF THE DRAWINGS

FIGS. 1A and 1B are top views showing one embodiment of the present invention, including exemplary embodiments of the booms, main wheels, carriages, and implements.

FIG. 2 is a side view of the embodiment shown in FIGS. 1A and 1B in the tilling configuration.

FIG. 3 is a side view of the embodiment shown in FIGS. 1A and 1B with the implements in the raised position and the main wheels configured so the embodiment can be moved laterally across a field to begin a new pass across the field.

FIG. 4 is a side view showing the soil compaction created by the embodiment shown in FIGS. 1A and 1B.

FIG. 5 is a drawing showing the soil compaction created by a conventional tillage system.

FIG. 6 is a perspective view showing one embodiment of a motor equipped wheeled support assembly included with the present invention.

FIG. 7 is a side view showing exemplary embodiments of the turn and lift sections of the booms, carriages, implements, and turn wheel mechanisms for turning the implements.

FIG. 8 is a side view showing exemplary embodiments of a wheeled boom support, a permanent boom section with trailer wheels, the turn and lift sections of the booms, the turn wheel mechanism for turning the implements, and an end plate that houses return pulleys.

FIG. 9 is an end view showing the wheeled boom support and exemplary embodiments of an end support beam, rolling boom supports, and suspended booms.

FIG. 10 is a top view showing bow the booms can be adjusted according to the number of implements being used.

FIG. 11 is an enlarged side view showing the trailer wheels in the stowed and travel Positions.

FIG. 12 is a cut-away, enlarged view showing the end support beam and rolling boom support brackets.

FIG. 13 is an enlarged view of one of the rolling boom support brackets shown in FIG. 12.

FIG. 14 is a view of the rolling boons support bracket shown in FIG. 13 rotated 180 degrees horizontally.

FIG. 15 is a side view showing the rolling boom support connected to the end support beam and a boom.

FIG. 16 is a side view showing one embodiment of a F-shaped support frame included with the turn wheel mechanism.

FIG. 17 is a top view of FIG. 16 showing one embodiment of a turn wheel connected to the F-shaped support frame.

FIG. 18 is an enlarged end view showing exemplary embodiments of the boom, carriage, carnage wheel track, carriage wheels, insert tubes included in the boom for receiving the F-shaped support frame, and turn wheel lift track.

FIG. 19 is a side view showing a second F-shaped support frame included with the turn wheel mechanism.

FIG. 20 is a top view of FIG. 19.

FIG. 21 is a cut-away end view showing the F-shaped support frames of the turn wheel mechanism connected to the turn section of the boom using the insert tubes.

FIG. 22 is a top view showing one of the turn wheels and a turn wheel bracket used to connect the turn wheel to the F-shaped support frame.

FIG. 23 is a front view of FIG. 22 showing one embodiment of a swivel arm included with the turn wheel mechanism.

FIG. 24 is a side view of FIG. 23.

FIG. 25a shows the carriage at a position just before it contacts the turn wheel and the swivel arm.

FIG. 25b shows the swivel arm being lifted by the carriage.

FIG. 25c shows the carriage right before it disengages with the swivel arm and turn wheel.

FIG. 25d shows the swivel arm in a locked position.

FIG. 26 shows a bottom view of one embodiment of a turntable included with the carriage.

FIG. 27 is a top view showing one embodiment of the four track wheels included with the carriage.

FIG. 28 is a side view of the carriage and the turntable shown in FIGS. 26 and 27.

FIG. 29 is a front view of the carriage and turntable shown in FIG. 28.

FIGS. 30a-30m show how the turn wheel mechanism rotates the turntable included with the carriage.

FIG. 31 is an enlarged side view of the end plate shown in FIG. 8.

FIG. 32 is an end view of the end plate shown in FIG. 31.

FIG. 33 is an end view of the end plate shown in FIG. 32 with increased spacing between the booms.

FIGS. 34-35 illustrate how power and hydraulics may be supplied by a conventional tractor in one embodiment of the invention.

### DETAILED DESCRIPTION OF THE INVENTION

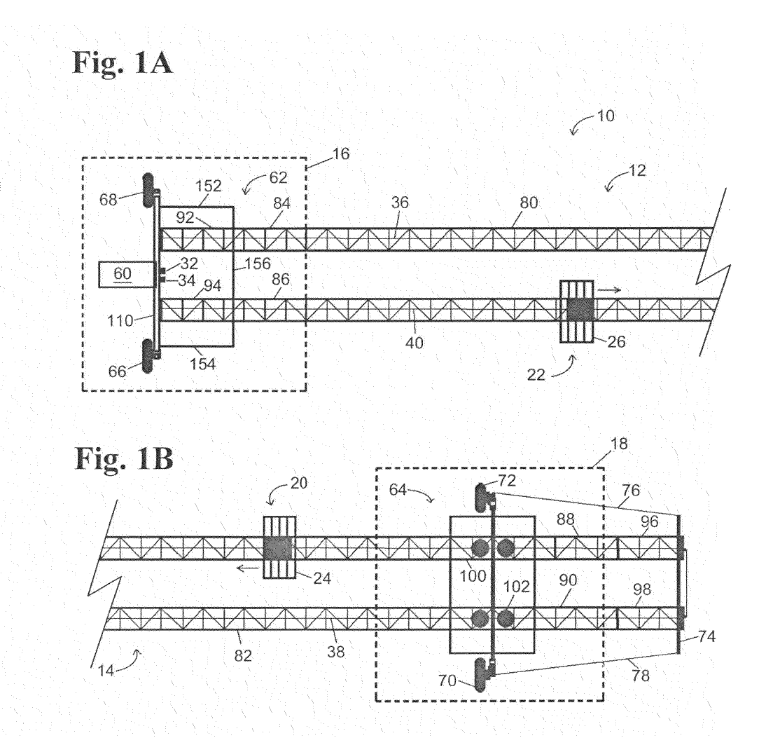

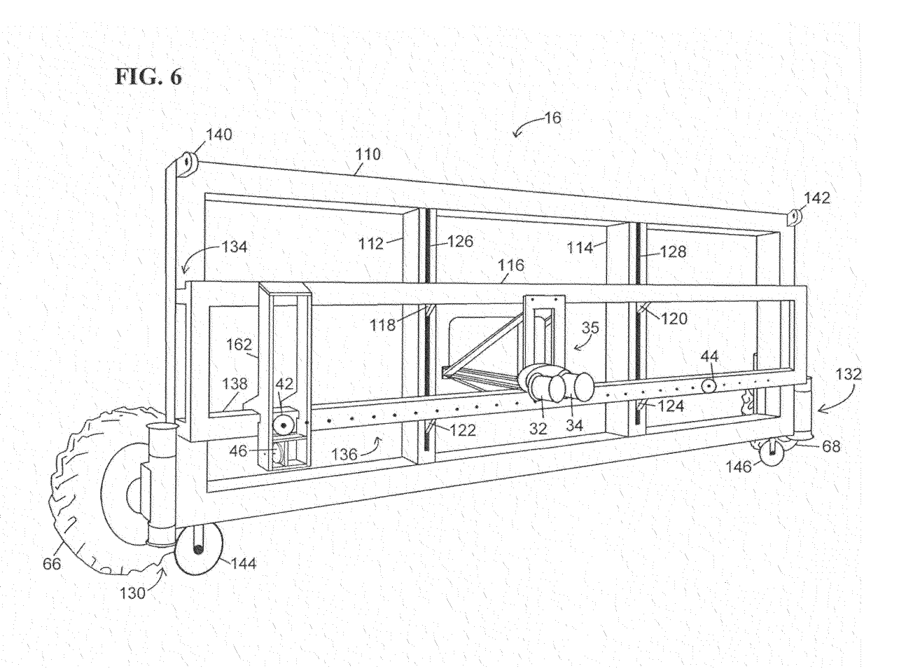

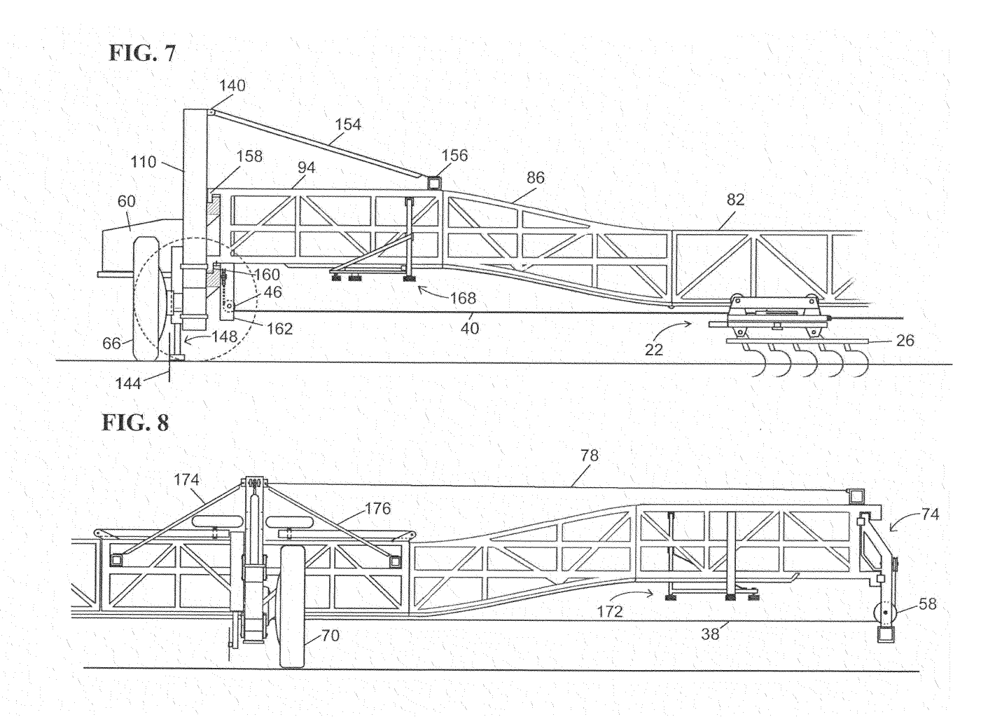

Referring to FIGS. 1A, 1B, and 2-3, one embodiment of the present invention of a traction tillage system 10 includes a pair of booms, 12 and 14, a pair of wheeled support assemblies, 16 and 18, connected to and providing support for the booms, a pair of carriages, 20 and 22, connected to the booms so that the carriages can move back and forth along the booms, implements, 24 and 26, connected to the carriages for tilling a field 30, and a carriage drive system (or pulley drive system) connected to the carriages and the booms for simultaneously moving the carriages in opposite directions along the booms and causing the implements to work against themselves creating their own traction in the process of tiding a field. Implements 24 and 20 may be plows or any other type of equipment used to till a field. Carriage drive system may include a pair of cable spools, 32 and 34, cables, 36, 38, and 40, a series of pulleys, 42 and 44 (FIG. 6), 46 (FIG. 7) and 48 (not shown), 50, 52, 56, and 58 (FIG. 32), and a motor or engine 60. The motor/engine and cable spools may be mounted on wheeled support assembly 16 using a motor/engine support frame 35, cable 36 may be connected to cable spool 32, pulleys 44 and 48, and one end of carriage 20, cable 38 may be connected to an opposite end of carriage 20, pulleys 50, 52, 56, and 58, and one end of carriage 22. Cable 40 may be connected to an opposite end of carriage 22, pulleys 46 and 42, and cable spool 34.

Motor/engine 60 may be a QSF2.8 (Tier 4 Final/Stage IV) motor manufactured by Cummins, Inc. or any other motor or engine capable of moving the carriages back and forth along the booms. Detailed information regarding the QSF2.8 engine may be found at cummingsengines.com.

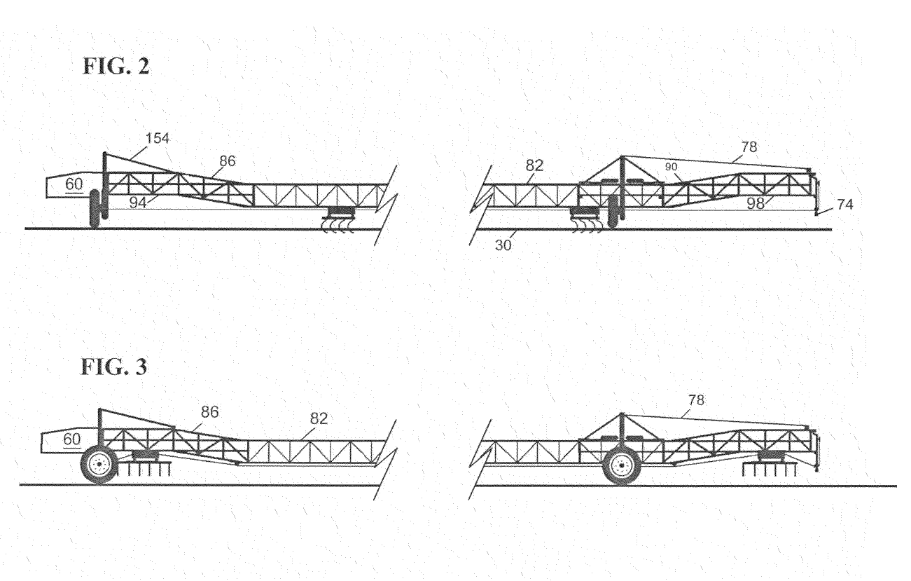

Wheeled support assembly 16 may include a first support frame 62 connected to the booms and wheeled support assembly 18 may include a second support frame 64 connected to the booms. Wheeled support assembly 16 may include a first set of main wheels, 66 and 68, and wheeled support assembly 18 may include a second set of main wheels, 70 and 72. The main wheels may be positioned in a tilling position, as shown in FIGS. 1 and 2, or rotated 90 degrees and positioned in a moving position as shown in FIG. 3.

When the equipment is operating, the main wheels allow the system 10 to be moved from one position to the next position which is parallel to the last position tilled. The system 10 docs not move to a new position while the implements are in the ground or moving back and forth across the field. When the system is moved into place, the implements are pulled by the cables in opposite directions until they reach the ends of the booms where they travel up the lift sections and are pulled out of the ground. When the implements are out of the ground, system 10 can move in a parallel manner to the next position.

When system 10 completes on pass and reaches the cud of the field, the main wheels, 66, 68, 70, and 72 turn 90 degrees and system 10 moves laterally across the field to the next tilling position. The system 10 may be moved so that the main wheels, 66 and 68, line up with the tracks made by the second set of main wheels, 70 and 72, when the system 10 is moved to the next position to reduce wheel tracks made by the system.

The system 10 may include an end plate 74 connected to booms 12 and 14 and boom support cables, 76 and 78, connected between the end plate 74 and wheeled support assembly 18 to provide additional support for booms 12 and 14.

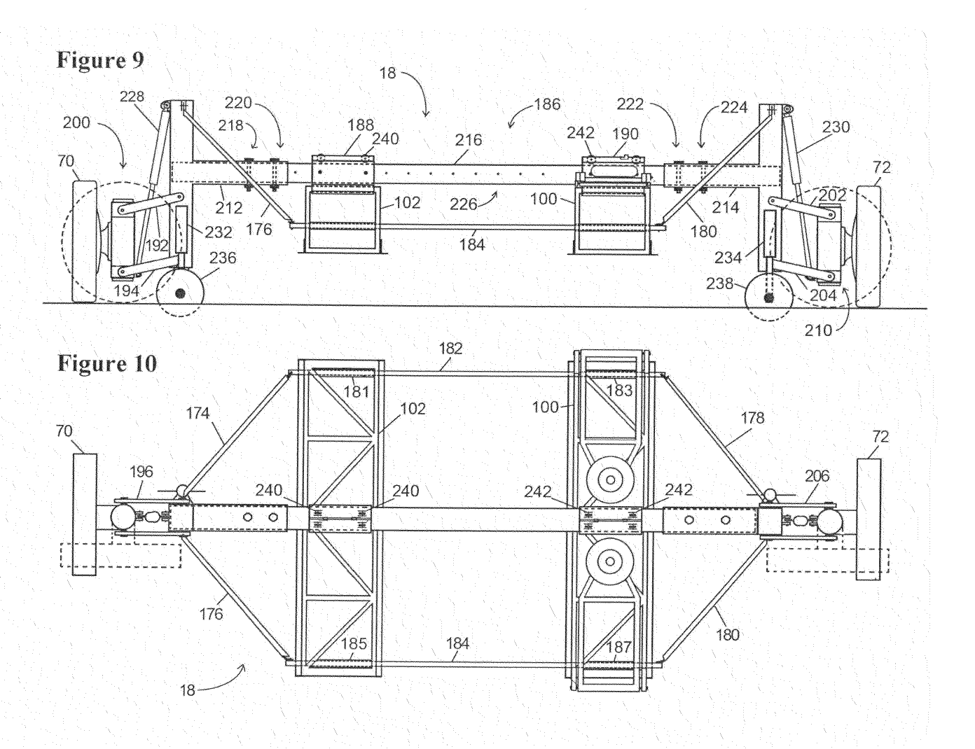

Booms 12 and 14 may include main boom sections 80 and 82, lift sections 84, 86, 88, and 90, and turn sections 92, 94,96, and 98. The lift and turn sections may be approximately equal in length and substantially shorter in length than the main boom sections. The main boom and turn sections may be substantially level and the lift sections may be sloped upward or inclined so that the implements move upward out of the ground as they travel up the lift sections. Booms 12 and 14 may also include wheeled boom support sections, 100 and 102 (FIG. 9), which may be included as part of wheeled support assembly 18.

The booms may be constructed from pipes, steels beams, or other similar materials used to make conventional booms used in the construction industry. The distance between the booms may be increased or decreased in order to accommodate different sized implements and the booms may be raised and lowered with respect to the wheeled support assemblies.

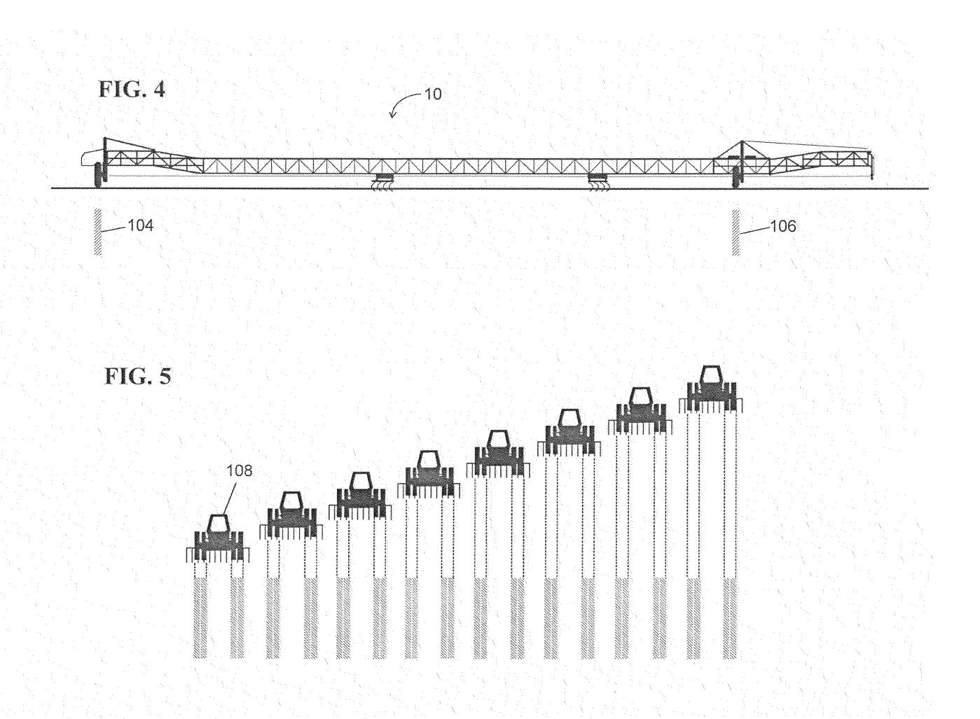

FIGS. 4 and 5 illustrate how the present invention can reduce soil compaction when compared to conventional field tillage systems. As shown in FIG. 4, the system of the present invention only creates two instances of soil compaction, 104 and 106, as it moves across a field. A conventional tractor 108 having four rear wheels would create a significantly higher number of instances of soil compaction when tilling the same field because it would have to move back and forth across the field multiple times in order to completely till the field.

As shown in FIG. 6, wheeled support assembly 16 may include a rectangular main frame 110 having two vertical support members, 112 and 114, and a rectangular hit frame 116 connected to the main frame 110. Wheeled support assembly 16 may include conventional hydraulic pistons or electric motors (not shown) inside the two vertical support members to move the hit frame up and down with respect to the main frame. Vertical support members 112 and 114 may include John Bean Auto Life, Symmetric Two Post Mfr. Model 421500S16. Wheeled support assembly 16 may include four support arms, 118, 120, 122, and 124, extending out from two slots, 126 and 128, defined on the vertical support members under the lift frame.

Main wheels, 66 and 68, may be connected to the main frame 110 using hinges, 130 and 132, that allow the main wheels to be positioned in the working position, where the wheels are parallel with the main frame 110, and rotated 90 degrees to the moving position, where the wheels are perpendicular to the main frame 110. Hydraulic motors, hydraulic pistons, or electric motors (not shown) may also be included in, or connected to, the main frame 110 for rotating the main wheels hack and forth between the tilling and moving positions.

Lift frame 116 may include an upper lip 134, which can be used to connect the booms 12 and 14 to the lift frame 116, and a series of holes 136 defined in a lower portion 138 of the lift frame 116, which can be used to connect pulleys, 42 and 44, to the lift frame 116 at various different locations depending on the positions of the booms 12 and 14.

Wheeled support assembly 16 may include a pair of brackets, 140 and 142, which can be used to connect the first support frame 62 to the main frame 110, and a pair of coulter wheels, 144 and 146, connected to the main frame 110 adjacent to the main wheels 66 and 68. Hydraulic jacks, 148 (FIG. 7) and 150 (not shown) may be connected to the main frame 110 for driving the coulter wheels down into the ground in order to prevent the system 10 from moving when the implements 24 and 26 encounter soil having different consistencies.

First support frame 62 may include a first pair of support struts, 152 (FIG. 1A) and 154 (FIG. 7) connected on one end to the main frame 110 using the brackets, 140 and 142, and on the opposite end to first support beam 156. First support beam 156, in turn, is connected to the booms 12 and 14 and, more specifically, to turn sections, 92 and 94. Turn sections 92 and 94 may be connected to lift frame 116 using locking tabs, 158 and 160. Wheeled support assembly 16 may include pulley support arms 162 (FIGS. 6 and 7) and 164 (not shown) connected to lift frame 116. Pulley support arms 162 and 164 may be connected to lift frame 116 so that they can be slid back and forth along the lift frame 116 and aligned with pulleys 42 and 44 when they are positioned in different locations along the lift frame 116.

As shown in FIGS. 7-8, the system 10 may include carriage turning mechanisms 166 (not shown), 168, 170 (not shown), and 172, for turning the carriages around after completing a pass across a field. Second support frame 64 (FIG. 1B) may include a second pair of support struts, 174 and 176 (FIG. 10), a third pair of support struts, 178 and 180, and a pair of second support beams, 182 and 184. Support beam 182 may be connected to wheeled boom support sections, 100 and 102, using hollow tubes 181 and 183, and support beam 184 may be connected to an opposite end of wheeled boom support sections 100 and 102 using hollow tubes 185 and 187.

Wheeled support assembly 18 (FIGS. 9-10) may include an I-shaped main frame 186, a pair of rolling brackets, 188 and 190, connected to the main frame 186 and the wheeled boom support sections, 100 and 102, of the first and second booms. Main wheel 70 is connected to the main frame 186 using a first set of four hinged spacer arms, 192, 194, 196, and 198 (not shown) and a first hinge 200 so that main wheel 70 can be rotated 90 degrees from a tilling position to a moving position. Main wheel 72 is connected to an opposite end of main frame 186 in a similar manner using a second set of four hinged spacer arms, 202, 204, 206, and 208 (not shown) and a second hinge 210 so main wheel 72 can be rotated 90 degrees from a oiling position to a moving position.

I-shaped main frame 186 may include two T-shaped members, 212 and 214, connected together using a main support beam 216, which is inserted inside the T-shaped members and secured using conventional nuts and bolts, 218, 220, 222, and 224. Main frame 186 may include a series of holes 226 that can be used to secure the rolling brackets, 188 and 190, in place along the main frame 186.

Wheeled support assembly 18 may include hydraulic pistons, 228 and 230, for raising and lowering the I-shaped main frame 186. Piston 228 is connected between hinge 200 and t-shaped member 212 and piston 230 may be connected between hinge 210 and t-shaped member 214. Wheeled support assembly 18 may also include hydraulic jacks, 232 and 234, for driving coulter wheels, 236 and 238, into the ground in order to prevent the system 10 from moving.

Rolling brackets 188 and 190 may be moved back and forth along main name 186 using rollers 240 and 242.

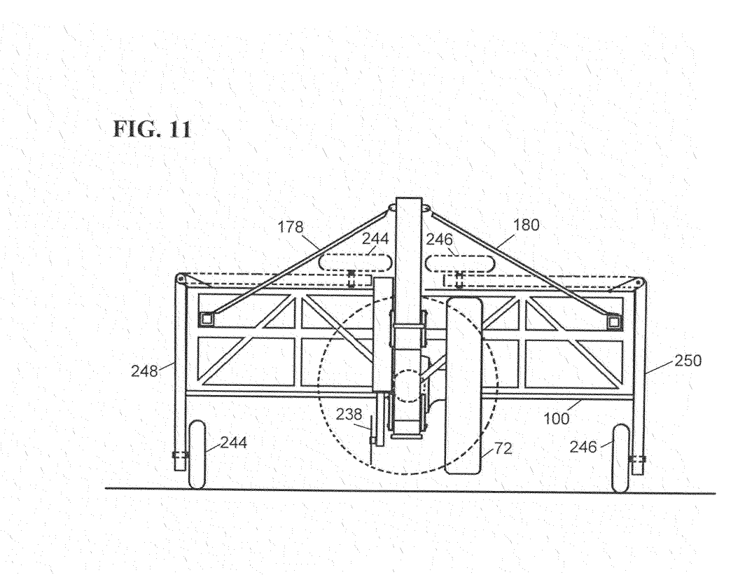

Wheeled support assembly 18 may include highway wheels, 244 and 246 (FIG. 11), connected to wheeled boom support section 100 using wheel support arms, 248 and 250, and binges, 252 and 254. These wheels can be rotated down into place when needed to move the wheeled support assembly 18 on a highway and then rotated back up so that they lay flat on top of wheeled boom support section 100 when not in use.

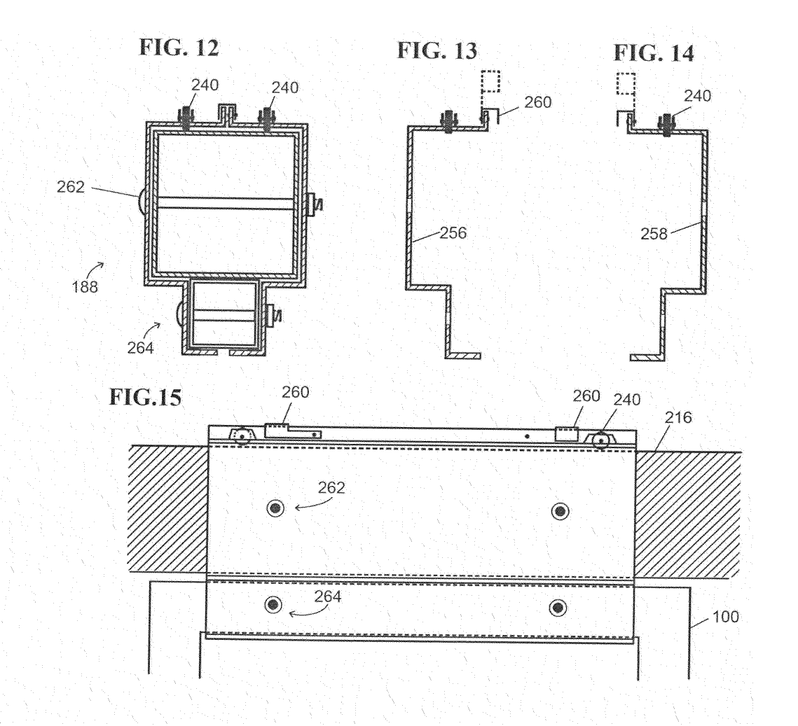

Referring to FIGS. 12-15, rolling bracket 188 may include two bracket pieces, 256 and 258, which are connected to main frame 186 using two u-clips 260, and conventional nuts and bolts, 262 and 264. Rolling bracket 188 may be connected to the main frame 186 and wheeled boom support section 100 by placing the bracket pieces on opposite sides of the support beam 216 and support section 100, holding the two bracket pieces together using the two u-clips 260, and then securing the two bracket pieces to the support section 216 and support section 100 using conventional nuts and bolts, 262 and 264.

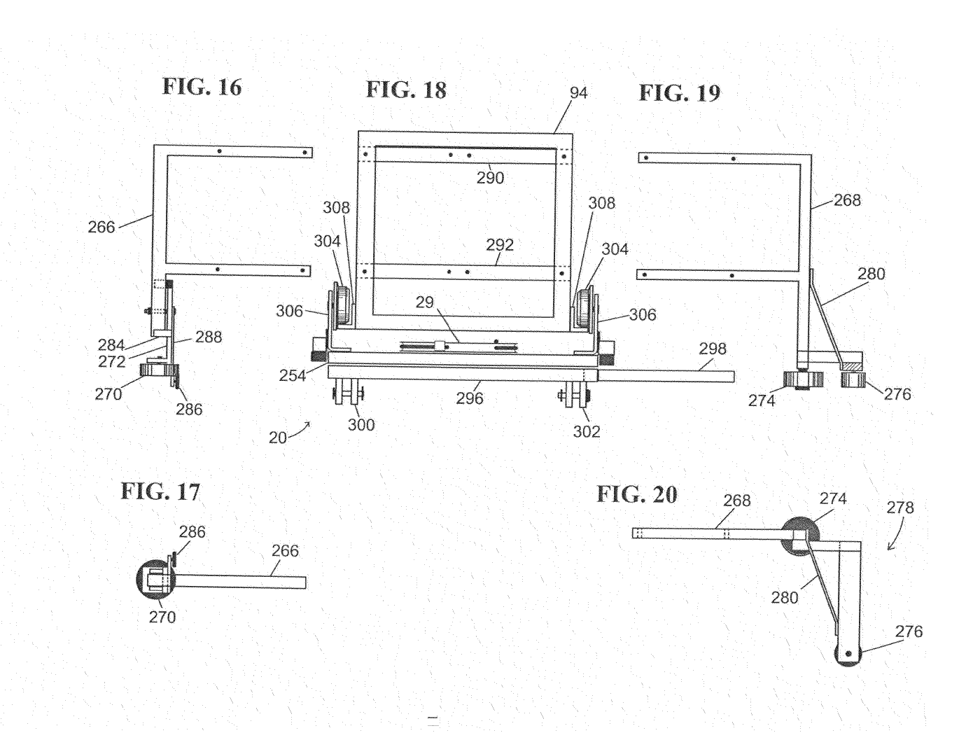

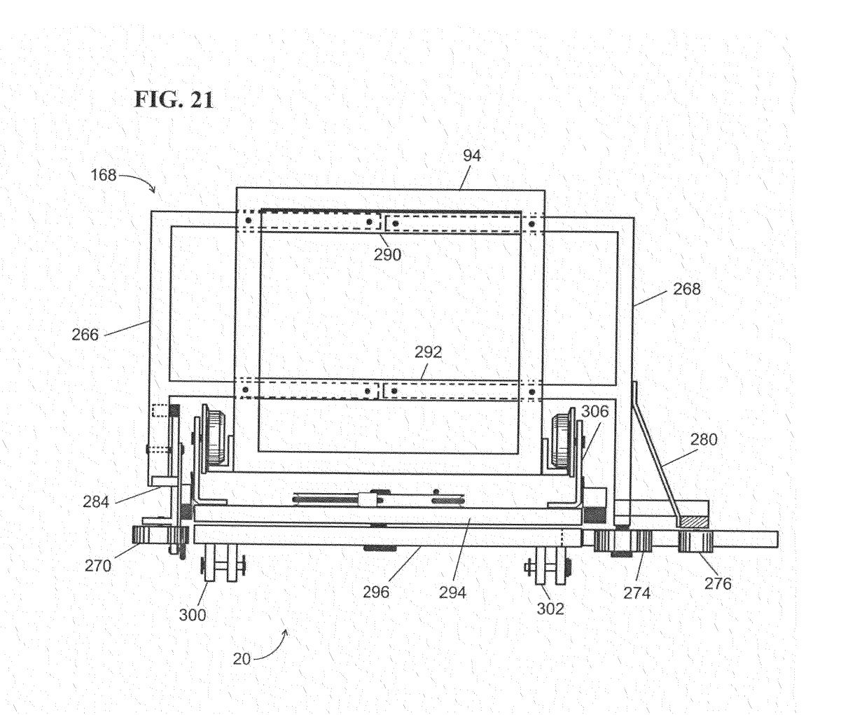

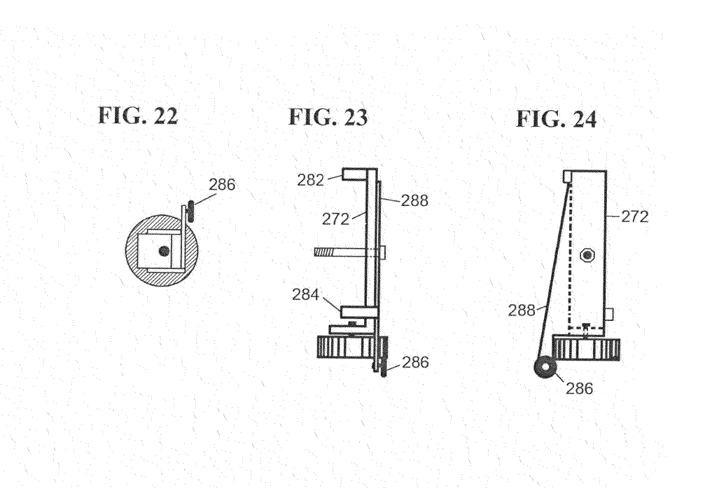

Carriage turning mechanism 168 (FIGS. 16-24) may include turning frame pieces, 266 and 268, return wheel 270 pivotally connected to frame piece 266 using a pivot arm 272, a large turn wheel 274 rotatably connected directly to frame piece 268, and small turn wheel 276 rotatably connected to frame piece 268 using L-shaped bracket 278 and support arm 280. Pivot arm 272 may include stops, 282 and 284, that prevent the pivot arm 272 from rotating in one direction, and a lift wheel 286 rotatably connected to the pivot arm 272 using bracket 288. Carriage turning mechanisms 166, 170 and 172 are constructed in a similar manner.

Frame pieces, 266 and 268, may be connected to turn section 94 using hollow tubes, 290 and 292, included as part of turn section 94. Frame pieces (not shown) for carriage turning mechanisms 166, 170, and 172 are connected to turn sections 92, 96, and 98 in a similar manner.

Carriage 20 may include a main body 294, a turntable 296, having a main turn arm 298 and secondary turn arm 299, rotatably connected to the main body 294, and brackets 300, which can be used to connect implement 24 to carriage 20. Carriage 20 may include four (4) rollers 304 (two of which are shown in FIG. 18) connected to the main body 294 using roller brackets 306. Booms 12 and 14, including turn section 94, may include roller tracks 308 that allow carriages 29 and 22 to rod back and forth along booms 12 and 14. Carriage 20 is identical to carriage 22.

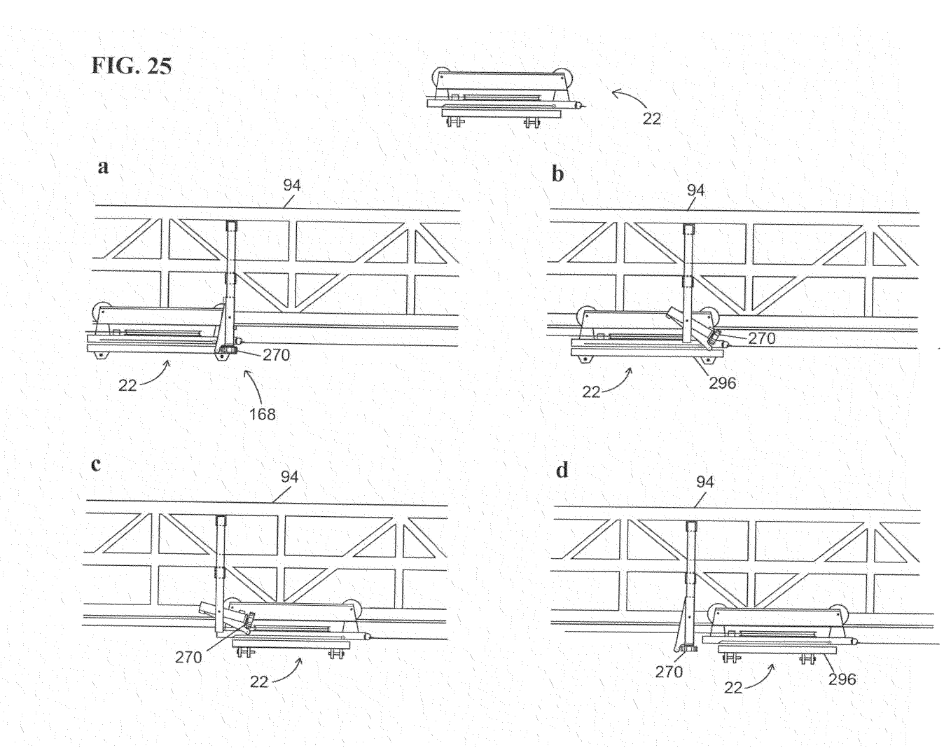

FIGS. 25a-d illustrates the operation of the return wheel 270 as carriage 22 moves past the carriage turning mechanism 168. As shown in these figures, return wheel 270 pivots up out of the way as the carriage 22 moves through the carriage turning mechanism 168 and then fails back down into place after the carriage 22 has moved past the mechanism 168.

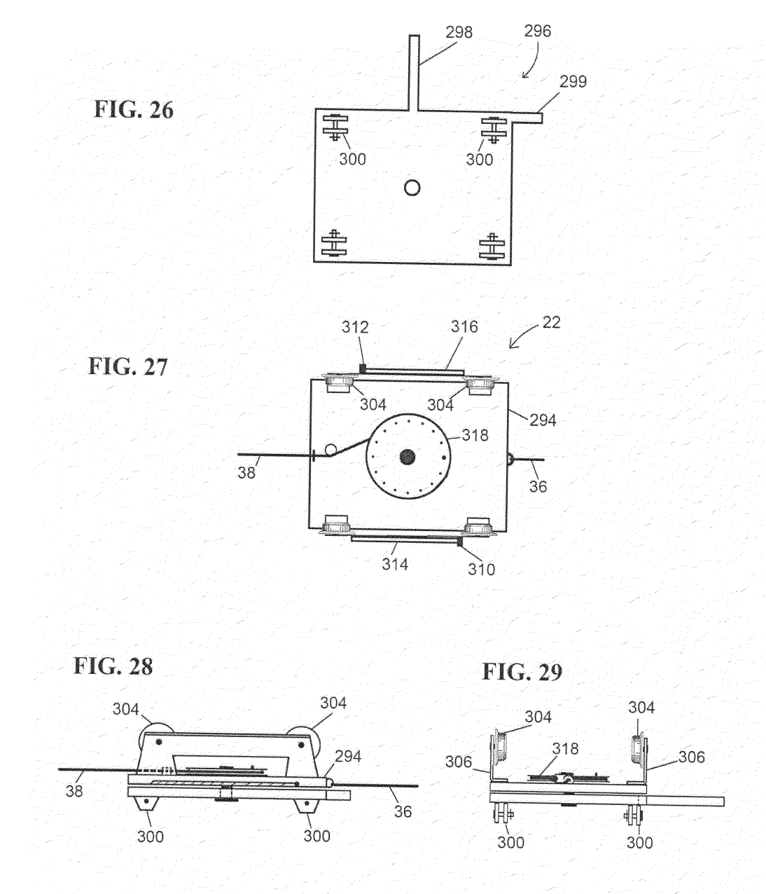

Carriage 22 (FIGS. 26-29) may include push wheels, 310 and 312, and lift wheel tracks, 314 and 316, connected on opposite sides of the main body 294. When carriage 22 moves through the carriage turning mechanism 168 as shown in FIGS. 25a-d, lift wheel 286 rolls up and over push wheel 310 and along lift wheel track 314. A cable spool 318 may be roiatably connected to the main body 294 and used to adjust the length of cable 38 when the distance between booms 12 and 14 is increased or decreased.

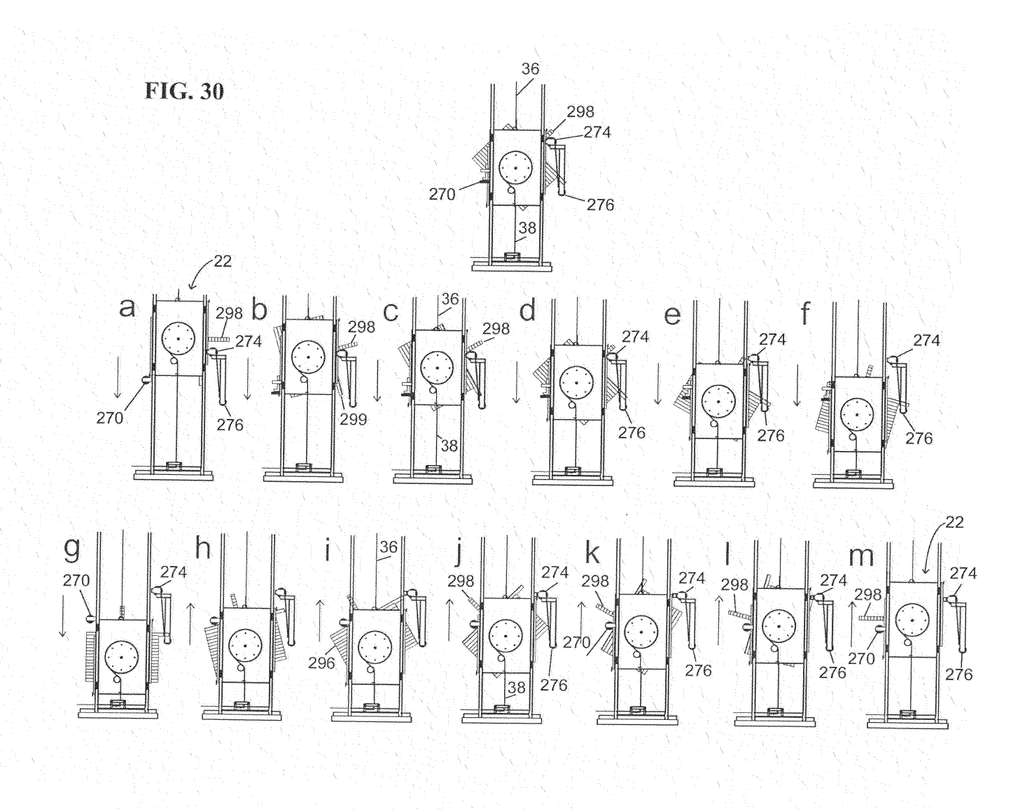

FIGS. 30a-m illustrate how carriage turning mechanism 168 rotates turntable 296 180 degrees as the carriage 22 is pulled past the turning mechanism 168 in one direction and then pulled past the turning mechanism 168 in the opposite direction. As shown in the figures, large turn wheel 274 pushes on turn arm 298 and initiates the rotation of the turntable 296 (FIGS. 30a-d). Small turn wheel 276 then engages with secondary turn arm 299 and continues rotating the turntable 296 until the turntable 296 has been rotated 90 degrees with respect to its initial position (FIGS. 30e-g). This completes the movement of carriage 22 past the turning mechanism 168 in the first direction. When the carriage 22 is then pulled back in the opposite direction, return wheel 270, which cannot pivot in this direction, engages with the turntable as shown in FIG. 30g and rotates the turntable 296 90 more degrees (FIGS. 30b-m).

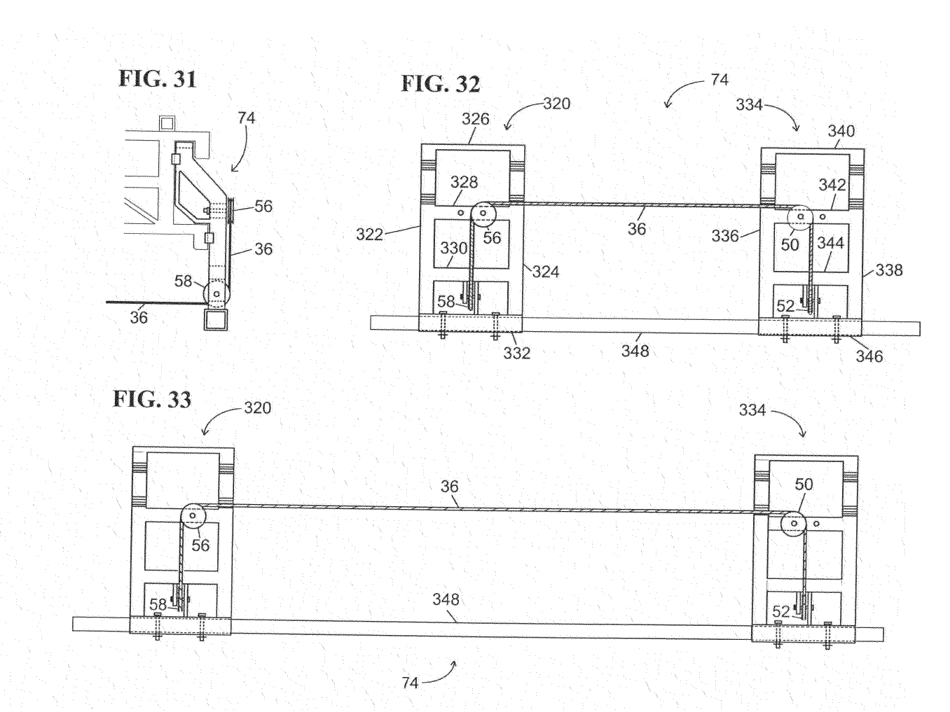

As shown in FIGS. 31-33, end plate 74 may include a first ladder-like structure 320 connected to a second ladder-like structure 334 using a main elongated support beam 348. First ladder-like structure may include a first pair of vertical support beams, 322 and 324, a first set of horizontal cross beams, 326, 328, and 330, connected at a top, middle, and lower portion of the first pair of vertical support beams, and a first hollow cross beam 332 connected to a bottom portion of the first pair of vertical support beams. Second ladder-like structure 334 may include a second pair of vertical support beams, 336 and 338, a second set of horizontal cross beams, 340, 342, and 344, connected at a top, middle, and lower portion of the second pair of vertical support beams, and a second hollow cross beam 346 connected to a bottom portion of the second pair of vertical support beams.

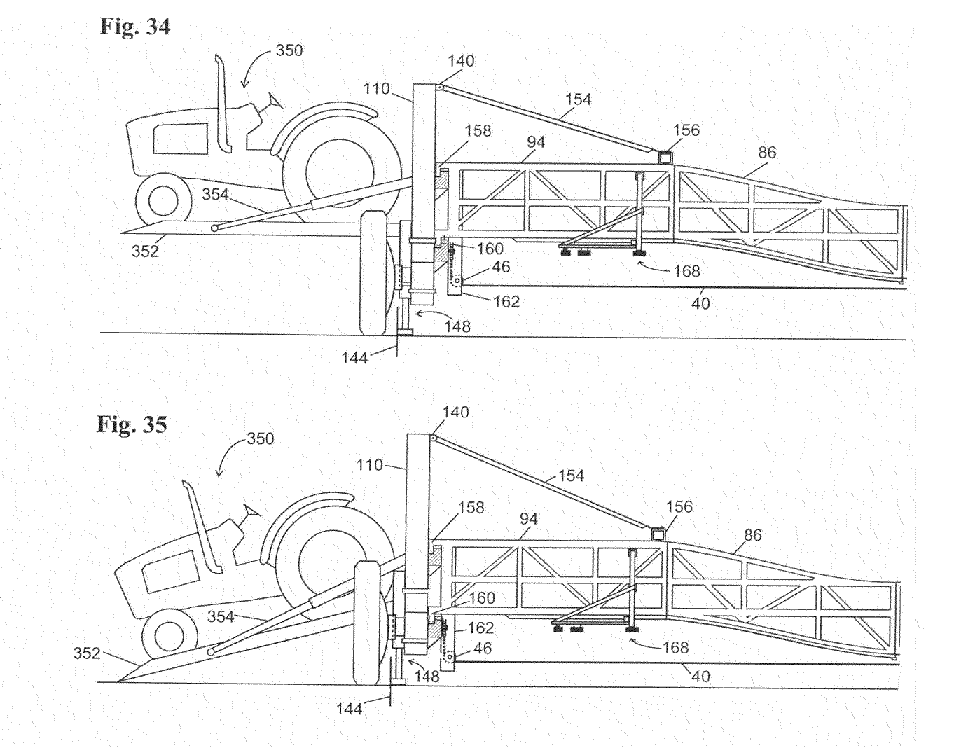

As shown in FIGS. 34-35, power and hydraulics may be supplied to the system 10 using a conventional tractor 350 and a lift platform 352. The lift platform 352 may be raised and lowered using a hydraulic lift 354. Tractor 350 Includes a motor (not shown), a clutch system (not shown), a power take-off (not shown) for driving the cable drums, 32 and 34, and hydraulics (not shown) for raising and lowering the wheeled support assemblies and turning the wheels connected to the wheeled support assemblies. The lift platform 352 may be connected to lift frame 116 (FIG. 6) and move up and down with the booms 12 and 14. Cable spools, 32 and 34, may be connected to a 3-point hitch (not shown) and the power take off included with the tractor 350. Hydraulic hoses (not shown) included with the system 10 may be connected to hydraulic connectors (not shown) included with the tractor 350. Electrical connectors (not shown) included with system 10 may be connected to electrical connectors (not shown) included with the tractor 350.

The above-described embodiments are merely possible examples of implementations set forth for a clear understanding of the principles of this disclosure. Many variations and modifications may be made to the above-described embodiments without departing substantially from the spirit and principles of the disclosure. All such modifications and variations are intended to be included herein within the scope of this disclosure and protected by the accompanying claims.

What is claimed is:

1. A tillage system, comprising:
a pair of booms;
a first wheeled support assembly connected to one end of the pair of booms;
an end plate assembly connected to an opposite end of the pair of booms;
a second wheeled support assembly connected to the pair of booms between the first wheeled support assembly and the end plate assembly;
first and second carriages connected to the pair of booms so that the carriages can move back and forth along the pair of booms;
implements connected to the first and second carriages for tilling a field; and
a pulley drive system connected to the first and second carriages, end plate assembly, and pair of booms for simultaneously moving the first and second carriages in opposite directions along the pair of booms.

2. The system of claim 1, wherein each one of the pair of booms includes:
turn sections located on opposite ends of the boom; and
lift sections located adjacent to the turn sections on opposite ends of the boom.

3. The system of claim 1, wherein each one of the pair of booms includes:
an elongated, substantially level center section;
inclined lift sections connected to opposite ends of the center section; and
substantially level tans sections connected to the inclined lift sections.

4. The system of claim 3, wherein:
the turn and lift sections have approximately equal length; and
the center section is substantially longer than the turn and lift sections.

5. The system of claim 1, wherein the first wheeled support assembly includes:
a rectangular frame;
a lift frame adjustably connected to the rectangular frame so that the lift frame can be moved up and down with respect to the rectangular frame; and
a pair of main wheels connected to opposite ends of the rectangular frame using a pair of hinge assemblies.

6. The system of claim 1, wherein the pulley drive system includes:
a motor mounted to the first wheeled support assembly;
first and second cable spools mounted to the first wheeled support assembly adjacent to the motor;
a first cable partially wrapped around the first cable spool, extending through a first cable pulley mounted on the first wheeled support assembly, and connected to one end of the first carriage;
a second cable connected to an opposite end of the first carriage, extending through a series of pulleys connected to the end plate, and connected to one end of the second carriage;
a third cable connected to an opposite end of the second carriage, extending through a second cable pulley mounted on the first wheeled support assembly, and partially wrapping around the second cable spool; and
wherein the motor is connected to and can drive the first and second cable spools in a first direction, which causes the carriages to move in one direction, and an opposite direction, which causes the carriages to move in an opposite direction.

7. The system of claim 1, wherein the end plate assembly includes:
a first ladder-like end plate having a first pair of vertical support beams, a first set of horizontal cross beams connected at a top, middle, and lower portion of the first pair of vertical support beams, and a first hollow cross beam connected to a bottom portion of the first pair of vertical support beams;
a second ladder-like end plate having a second pair of vertical support beams, a second set of horizontal cross beams connected at a top, middle, and lower portion of the second pair of vertical support beams, and a second hollow cross beam connected to a bottom portion of the second pair of vertical support beams; and
a main elongated support beam connected between the first and second ladder-like end plates using the first and second hollow cross beams.

8. The system of claim 1, wherein the second wheeled support assembly includes:
a first t-shaped support member;
a second t-shaped support member;
a main support beam, connected between the first and second t-shaped support members; and
a pair of rolling boom support brackets connected to the main support beam and the pair of booms.

9. A field tillage system, comprising:
first and second booms having lift and turn sections;
first and second carriages connected to the first and second booms so that the first and second carriages can move back and forth along the first and second booms;
first and second implements connected to the first and second carriages for tilling a field;
first and second wheeled support assemblies connected to the first and second booms for supporting the first and second booms; and
a carriage drive system connected to the first and second carriages and the first and second booms for simultaneously moving the first and second carriages in opposite directions along the first and second booms.

10. The system of claim 9, wherein the first carriage includes a carriage body, a plurality of rollers connected to an upper portion of the carriage body, a turntable rotatably connected to a lower portion of the carriage body, and a plurality of connectors extending outward from a lower portion of the turntable for connecting the first implement to the first carriage.

11. The system of claim 10, further comprising a carriage turning mechanism connected to the first boom, the carriage turning mechanism including a turn frame connected to the turn section of the first boom, a return wheel connected to one side of the turn frame using a pivot arm and stops that allow the return wheel to pivot in only one direction, a first turn wheel connected to an opposite side of the turn frame, and a second turn wheel connected to the turn frame adjacent to the first turn wheel using an L-shaped bracket.

12. The system of claim 11, wherein the first wheeled support assembly includes a main frame, a lift frame connected to the main frame so that the lift frame can be moved up and down with respect to the main frame, and a first set of main wheels connected to the main frame using a first set of hinges so that the first set of main wheels can be rotated 90 degrees from a tilling position to a moving position.

13. The system of claim 12, wherein the second wheeled support assembly includes an I-shaped main frame, a pair of rolling brackets connected to the main frame and the first and second booms, and a second set of main wheels connected to the main frame using spacer arms and a second set of hinges so the second set of main wheels can be rotated 90 degrees from a tilling position to a moving position.

14. The system of claim 13, wherein the carriage drive system includes a set of pulley spools connected to the first wheeled support assembly, a plurality of pulleys connected to the first wheeled support assembly and an end plate connected to one end of the first and second booms, a plurality of cables connected to the pulley spools, the plurality of pulleys, and the first and second carriages, and a motor connected to the first wheeled support assembly for driving the pulley spools and cables.

15. A traction tillage system, comprising:
first and second booms having lift, turn, and wheeled boom support sections;
first and second carriages connected to the first and second booms so the first and second carriages can move back and forth along the first and second booms;
first and second implements connected to the first and second carriages for tilling a field;
first and second wheeled support assemblies connected to the first and second booms for supporting the first and second booms, the first wheeled support assembly including a main frame, a lift frame adjustably connected to the main frame so that the lift frame can be moved up and down, with respect to the main frame, and a first set of main wheels connected to the main frame using a first set of binges so the first set of main wheels can be rotated 90 degrees from a tilling position to a moving position;
a carriage drive system connected to the first and second carriages and the first and second booms for simultaneously moving the first and second carriages in opposite directions along the first and second booms; and
first and second carriage turning mechanisms connected to the first and second booms, the first carnage turning mechanism including a turn frame connected to the turn section of the first boom, a return wheel connected to one side of the turn frame using a pivot arm and stops that allow the return wheel to pivot in only one direction, a first turn wheel connected to an opposite side of the turn frame, and a second turn wheel connected to the turn frame adjacent to the first turn wheel, using an L-shaped bracket.

16. The system of claim 15, wherein the first carriage includes a carriage body, a plurality of rollers connected to an upper portion of the carriage body, a turntable rotatably connected to a lower portion of the carriage body, and a plurality of connectors extending outward from a lower portion of the turntable for connecting the first implement to the first carriage.

17. The system of claim 16, wherein the second wheeled support assembly includes an I-shaped main frame, a pair of rolling brackets connected to the main frame and the wheeled boom support sections, and a second set of main wheels connected to the main frame using spacer arms and a second set of hinges so the second set of main wheels can be rotated 90 degrees from a tilling position to a moving position.

18. The system of claim 17, further comprising an end plate assembly connected to one end of the first and second booms, the end plate assembly including:
a first ladder-like end plate having a first pair of vertical support beams, a first set of horizontal cross beams connected at a top, middle, and lower portion of the first pair of vertical support beams, and a first hollow cross beam connected to a bottom portion of the first pair of vertical support beams;
a second ladder-like end plate having a second pair of vertical support beams, a second set of horizontal cross beams connected at a top, middle, and lower portion of the second pair of vertical support beams, and a second hollow cross beam connected to a bottom portion of the second pair of vertical support beams; and
a main elongated support beam connected between the first and second ladder-like end plates using the first and second hollow cross beams.

19. The system of claim 18, wherein the first wheeled support assembly further includes a first set of coulter wheels connected to the main frame adjacent to the first set of main wheels using a first set of jack mechanisms.

20. The system of claim 19, wherein the second wheeled support assembly further includes highway wheels connected to the wheeled boom support sections using highway wheel hinges that allow the highway wheels to be rotated from a stored position to a traveling position.
